(19) United States
(12) Patent Application Publication
(10) Pub. No.: US 2020/0059146 A1
(43) Pub. Date: Feb. 20, 2020

(54) ELECTROMAGNETIC ACTUATOR

(71) Applicant: LOTES CO., LTD, Keelung (TW)

(72) Inventors: Tuan Chung Wang, Keelung (TW); Chien Hung Ho, Keelung (TW)

(21) Appl. No.: 16/543,750

(22) Filed: Aug. 19, 2019

(30) Foreign Application Priority Data
Aug. 20, 2018 (CN) 201810949403.9
Nov. 13, 2018 (CN) 201811347056.9

(51) Int. Cl. H02K 33/10

(52) U.S. Cl. CPC H02K 33/10

(57) ABSTRACT

An electromagnetic actuator includes: a rotor assembly, including an inner pipe and at least one magnet accommodated in the inner pipe; a stator assembly, sleeved over the rotor assembly; and at least one elastic member, located at one end of the rotor assembly. The stator assembly includes an outer pipe made of metal and sleeved over the inner pipe and at least one coil fixed outside the outer pipe. The coil applies a driving force to the magnet, and the magnet drives the entire rotor assembly to move along an extending direction of the outer pipe. An outer diameter of the inner pipe is less than an inner diameter of the outer pipe, and a shape of the outer pipe is identical to a shape of the inner pipe.

### CROSS-REFERENCE TO RELATED PATENT APPLICATION

This non-provisional application claims priority to and the benefit of, pursuant to 35 U.S.C. § 119(a), patent application Serial No. CN201810949403.9 filed in China on Aug. 20, 2018, and patent application Serial No. CN201811347056.9 filed in China on Nov. 13, 2018. The disclosure of the above application is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates to an electromagnetic actuator, and particularly to an electromagnetic actuator with a two-layer tubular structure.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Chinese Patent Application No. CN201310323117.9 discloses a vibration actuator, which has a basket body. The basket body accommodates a coil fixed to the basket body, a wire winding pipe encircled and fixed by the coil and made of resin, a cylindrical sliding block partially accommodated in the wire winding pipe, a magnet accommodated in the cylindrical sliding block, and a first hammer portion and a second hammer portion fixed at two ends of the cylindrical sliding block. Springs are provided between the first and second hammer portions and the basket body. The coil is conducted with power to form an electromagnetic field interacting with the magnet to drive the magnet, and the magnet then drives the cylindrical sliding block and the first and second hammer portions to move. Because the cylindrical sliding block is accommodated in the wire winding pipe, the cylindrical sliding block, the magnet accommodated in the cylindrical sliding block, and the first and second hammer portions fixed to the cylindrical sliding block can only move along an extending direction of the wire winding pipe.

The wire winding pipe is made of resin, and the strength is limited, such that the wire winding pipe may easily deform. Once the wire winding pipe deforms, an accommodating space of the wire winding pipe that accommodates the cylindrical sliding block does not extend along a straight line any more, and linear vibration of the cylindrical sliding block cannot be ensured.

The strength of the wire winding pipe can be improved by increasing a thickness of the wire winding pipe, which can resolve the foregoing problems to a certain extent. As shown in the accompanying drawings of CN201310323117.9, the thickness of the wire winding pipe is significantly greater than the thickness of the cylindrical sliding block. However, when the thickness of the wire winding pipe is increased, a distance between the coil and the magnet is also increased, and a driving effect of the coil on the magnet is weakened.

Therefore, a heretofore unaddressed need to design a new electromagnetic actuator exists in the art to address the aforementioned deficiencies and inadequacies.

### SUMMARY

In view of the deficiency in the background, the present invention is directed to an electromagnetic actuator with a two-layer tubular structure, where a stator assembly has a metal tubular structure.

To achieve the foregoing objectives, the present invention adopts the following technical solution:

An electromagnetic actuator includes: a rotor assembly, including an inner pipe and at least one magnet accommodated in the inner pipe; a stator assembly, sleeved over the rotor assembly, wherein the stator assembly comprises an outer pipe made of metal and sleeved over the inner pipe and at least one coil fixed outside the outer pipe, the at least one coil applies a driving force to the at least one magnet, and the at least one magnet drives the entire rotor assembly to move along an extending direction of the outer pipe; and at least one elastic member, located at one end of the rotor assembly, wherein an outer diameter of the inner pipe is less than an inner diameter of the outer pipe, and a shape of the outer pipe is identical to a shape of the inner pipe.

In certain embodiments, the inner pipe is made of metal.

In certain embodiments, a length of the outer pipe is less than a length of the inner pipe, and when the rotor assembly moves, two tail ends of the inner pipe remain outside the outer pipe.

In certain embodiments, when the rotor assembly does not move, the outer pipe is medially sleeved over the inner pipe.

In certain embodiments, a length of the outer pipe is greater than a length of the inner pipe, and when the rotor assembly moves, the entire inner pipe is completely accommodated in the outer pipe.

In certain embodiments, when the rotor assembly does not move, the inner pipe is medially accommodated in the outer pipe.

In certain embodiments, two ends of the inner pipe are provided with two plug members.

In certain embodiments, an inner surface of the inner pipe has two bumps, each of the plug members has a recess, and each of the bumps and the corresponding recess engage with each other so as to fix the plug members to the inner pipe.

In certain embodiments, each of the plug members has a passage, and the passage extends into the inner pipe from an exterior of the inner pipe.

In certain embodiments, at least one of the two plug members is provided with a stopping portion abutting a tail end of the inner pipe in an extending direction of the inner pipe.

In certain embodiments, a longitudinal sectional shape and a cross sectional shape of the outer pipe are respectively identical to a longitudinal sectional shape and a cross sectional shape of the inner pipe.

In certain embodiments, at least one groove is provided between two tail ends of the outer pipe, configured to reduce an eddy current generated on the outer pipe when the magnet moves along the outer pipe.

In certain embodiments, the electromagnetic actuator is accommodated in a shell, and the elastic member is a leaf spring, including: a first elastic sheet connected to the rotor assembly; a second elastic sheet connected to the shell; and a bending portion connecting the first elastic sheet and the second elastic sheet.

The outer pipe is made of metal. Compared with resin of a same thickness, the strength of the outer pipe can be improved, preventing the outer pipe from deforming and interfering with the movement of the inner pipe, thereby improving stability of the electromagnetic actuator. Compared with resin of same strength, a thickness of a pipe wall can be reduced, such that the coil is closer to the magnet, improving a driving effect of the coil on the magnet and reducing the volume thereof.

An electromagnetic actuator includes: a rotor assembly, including two magnets; and a stator assembly, sleeved over the rotor assembly, wherein the stator assembly comprises an outer pipe made of metal and sleeved over the magnets and at least one coil fixed outside the outer pipe, the at least one coil applies a driving force to the magnets, and the magnets drive the entire rotor assembly to move along an extending direction of the outer pipe, wherein the outer pipe is provided with at least one groove used configured to reduce an eddy current generated on the outer pipe when the magnets move along the outer pipe.

In certain embodiments, a length of the groove is greater than ½ of a length of the outer pipe.

In certain embodiments, an area of the groove is greater than an area of a metal portion of the outer pipe.

In certain embodiments, the outer pipe has two side walls and two connecting portions, each of the two connecting portions is located between the groove and a corresponding one of two tail ends of the outer pipe, and the connecting portions are configured to connect the two side walls.

In certain embodiments, the stator assembly further includes at least one fixing member, and one of the at least one fixing member has a protruding block accommodated in one of the at least one groove.

In certain embodiments, the at least one groove is located between two tail ends of the outer pipe.

In certain embodiments, the rotor assembly further includes an inner pipe accommodating the magnets, the inner pipe and the magnets jointly move, and the outer pipe is sleeved over the inner pipe.

In certain embodiments, the electromagnetic actuator further includes at least one elastic member provided on at least one end of the rotor assembly.

In certain embodiments, the electromagnetic actuator is accommodated in a shell, and the elastic member is a leaf spring, including: a first elastic sheet connected to the rotor assembly; a second elastic sheet connected to the shell; and a bending portion connecting the first elastic sheet and the second elastic sheet.

Compared with the related art, certain embodiments of the present invention have the following beneficial effects:

The outer pipe is made of metal. Compared with resin of a same thickness, the strength of the outer pipe can be improved, preventing the outer pipe from deforming and interfering with the movement of the inner pipe, thereby improving stability of the electromagnetic actuator. Compared with resin of same strength, a thickness of a pipe wall can be reduced, such that the coil is closer to the magnet, improving a driving effect of the coil on the magnet and reducing the volume thereof. When the magnet moves in the outer pipe made of metal, due to the Lenz's law, the outer pipe generates an induction current hindering movement of the magnet. By providing the slot on the outer pipe made of metal, the generation of the induction current may be prevented.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is an exploded view of an electromagnetic actuator according to a first embodiment of the present invention.

FIG. 2 is a partial assembled view of FIG. 1.

FIG. 3 is a partial assembled view of FIG. 2.

FIG. 4 is a partial sectional view of a rotor assembly and a stator assembly according to the first embodiment of the present invention.

FIG. 5 is a sectional view of an outer pipe, an inner pipe and a magnet being sleeved and assembled according to the first embodiment of the present invention.

FIG. 6 is a sectional view of an electromagnetic actuator according to the first embodiment of the present invention, where the rotor assembly is in an initial state.

FIG. 7 is a sectional view of an electromagnetic actuator according to the first embodiment of the present invention, where the rotor assembly is in a moving state.

FIG. 8 is a partial exploded view of an electromagnetic actuator according to a second embodiment of the present invention.

FIG. 9 is a perspective view of a rotor assembly according to the second embodiment of the present invention;

FIG. 10 is a sectional view of an electromagnetic actuator according to the second embodiment of the present invention, where the rotor assembly is in an initial state.

FIG. 11 is a sectional view of an electromagnetic actuator according to the first embodiment of the present invention, where the rotor assembly is in a moving state.

FIG. 12 is a perspective view of an outer pipe sleeved over a rotor assembly according to a third embodiment of the present invention.

FIG. 13 is a perspective view of a stator assembly according to a fourth embodiment of the present invention.

FIG. 14 is a right view of FIG. 13.

FIG. 15 is a perspective view of an outer pipe in FIG. 13.

FIG. 16 is a partial exploded view of an electromagnetic actuator according to a fifth embodiment of the present invention.

FIG. 17 is a top view of FIG. 16.

### DETAILED DESCRIPTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

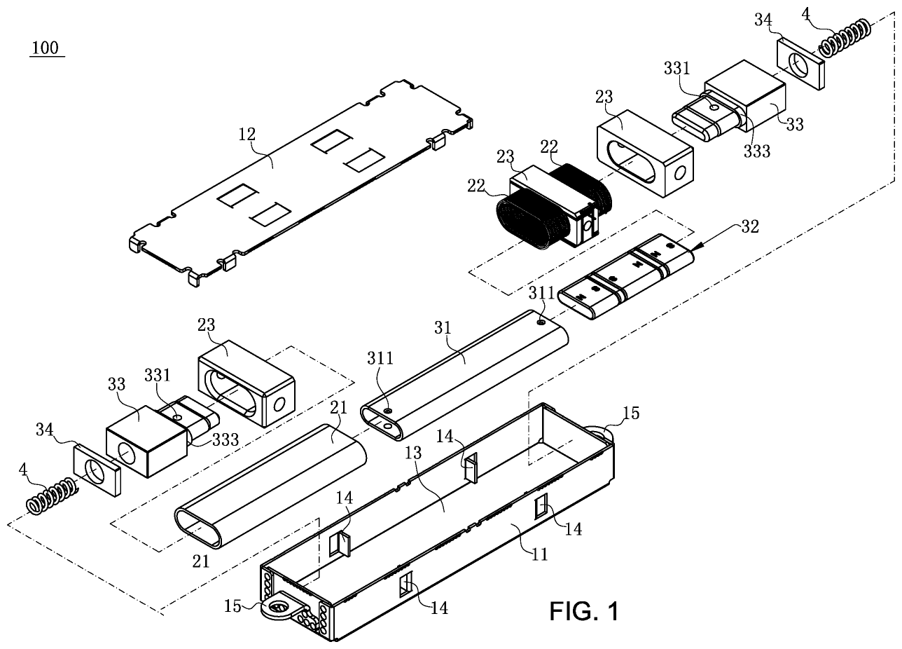

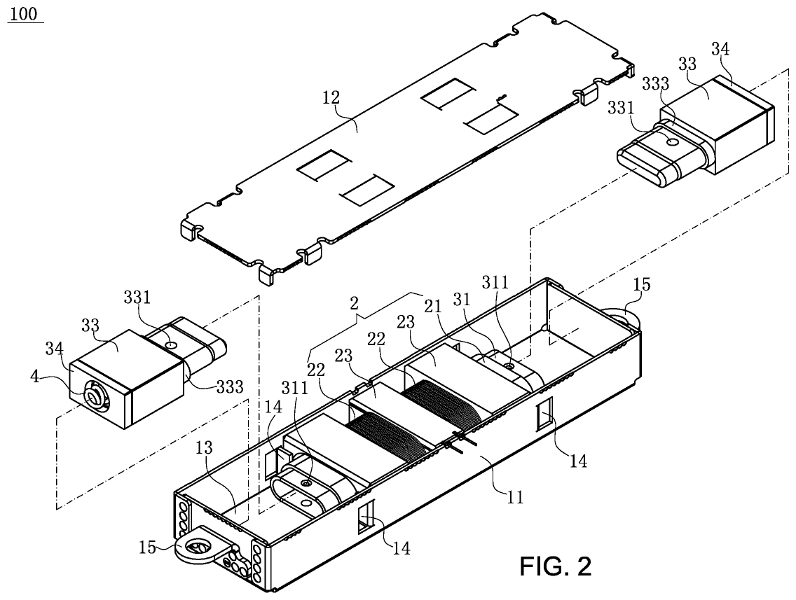

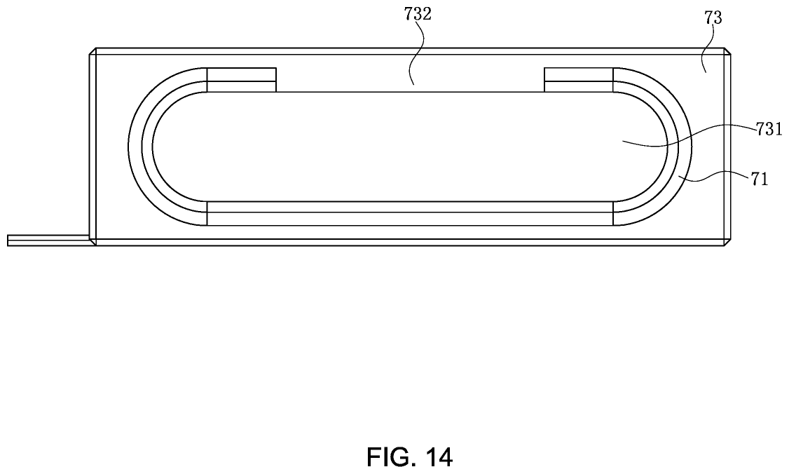

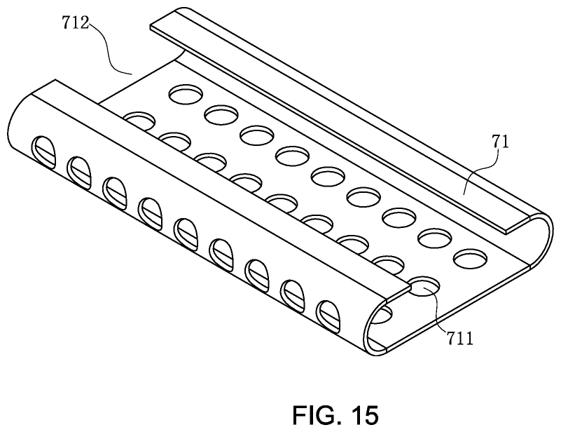

The description will be made as to the embodiments of the present invention in conjunction with the accompanying drawings in FIGS. 1-17. In accordance with the purposes of this invention, as embodied and broadly described herein, this invention, in one aspect, relates to an electromagnetic actuator.

FIG. 1 to FIG. 7 show an electromagnetic actuator 100 according to a first embodiment of the present invention, which includes: a shell 1, a stator assembly 2 accommodated in the shell 1, a rotor assembly 3 sleeved in the stator assembly 2, and two elastic members 4 located between the rotor assembly 3 and the shell 1.

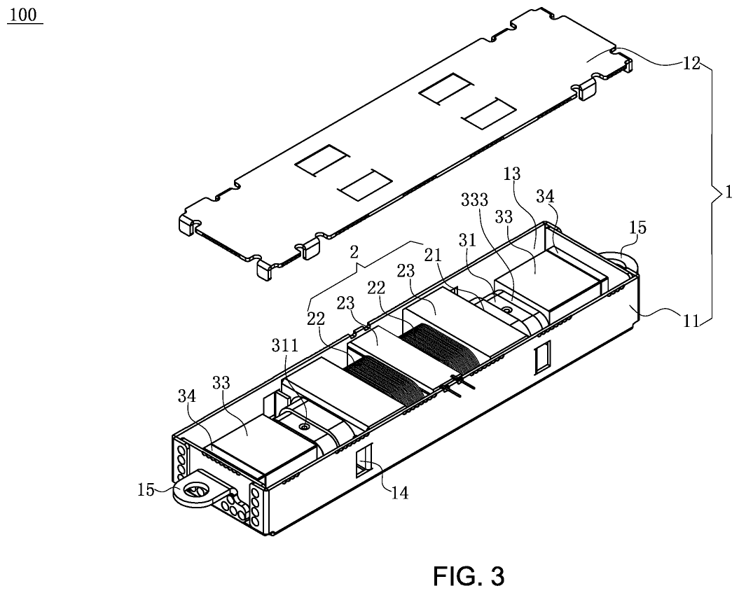

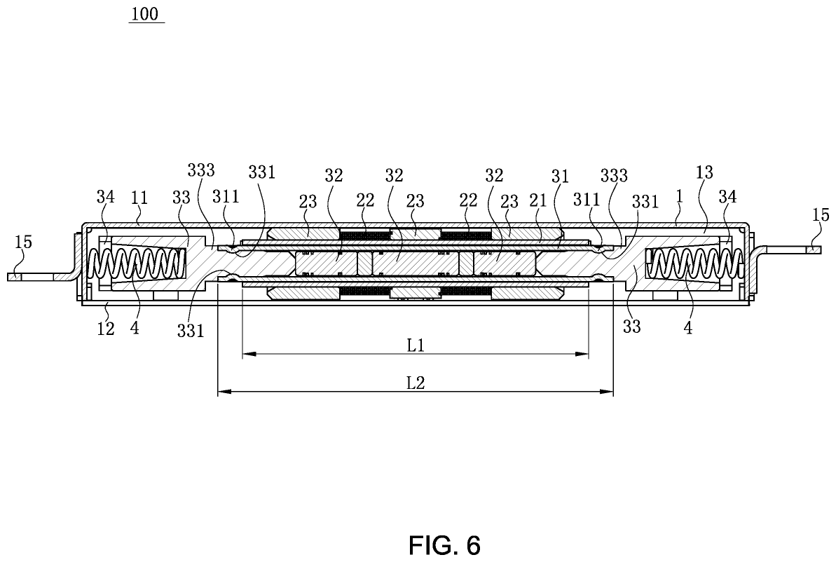

As shown in FIG. 3 and FIG. 6, the shell 1 includes a first shell 11 and a second shell 12, and the first shell 11 and the second shell 12 are assembled to form an accommodating space 13 for accommodating the stator assembly 2, the rotor assembly 3 and the two elastic members 4. In this embodiment, the first shell 11 is in a square box shape, the second shell 12 is in a flat plate shape, and the accommodating space 13 defined by the first shell 11 and the second shell 12 is rectangular. In other embodiments, the shell 1 and the accommodating space 13 therein may alternatively be in other shapes, and are not limited thereto. Two longitudinal side walls of the first shell 11 are respectively provided with two stopping sheets 14 bending towards the accommodating space 13 to fix the stator assembly 2. Two longitudinal ends of the first shell 11 are further provided with two retaining members 15, which can fit with bolts (not shown in the figures) to fix the electromagnetic actuator 100 to at least one substrate (not shown in the figures).

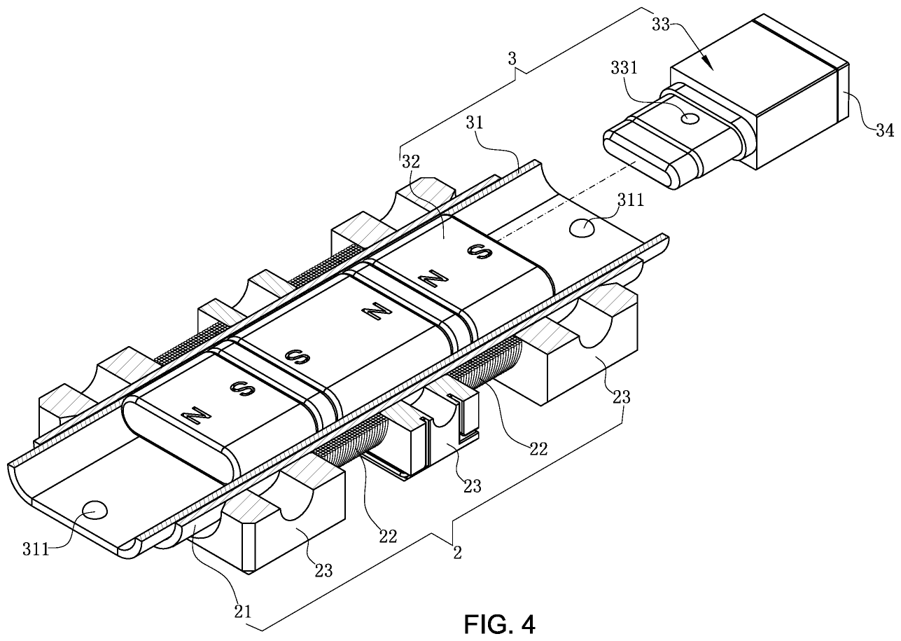

As shown in FIG. 3, FIG. 4 and FIG. 6, the stator assembly 2 includes a longitudinal outer pipe 21, two coils 22 wound on an outer surface of the outer pipe 21 and three fixing members 23. The outer pipe 21 may be made of metal and has smooth inner and outer surfaces, and is medially accommodated in the shell 1. Specifically, the outer pipe 21 is located at a center location of the shell 1 in a longitudinal direction, such that the outer pipe 21 is “medially” accommodated in the shell 1. In other words, in the longitudinal direction, a distance between one end of the outer pipe 21 and the shell 1 equals to a distance between the other end of the outer pipe 21 and the shell 1. The fixing members 23 are made of an insulating material, and may be fixed to the outer pipe 21 by insert molding, assembling, engaging, or other manners. The three fixing members 23 and the two coils 22 are arranged at intervals along a longitudinal direction of the outer surface of the outer pipe 21. Each two adjacent fixing members 23 clamp one coil 22 to prevent the coil 22 from sliding, and then the fixing members 23 are fixed to the shell 1 by glue dispensing, adhering agent, bolt fixing, or other fixing manners, such that the entire stator assembly 2 and the shell 1 remain relatively static.

As shown in FIG. 1, FIG. 4 and FIG. 6, the rotor assembly 3 includes an inner pipe 31 accommodated in the outer pipe 21, a magnet 32 accommodated in the inner pipe 31, and two plug members 33 fixed to two ends of the inner pipe 31. Inner surfaces of two longitudinal ends of the inner pipe 31 are respectively provided with two opposite upper and lower bumps 311, and an upper side and a lower side of each plug member 33 are respectively provided with a recess 331. The plug member 33 is partially accommodated in the inner pipe 31, and the recesses 331 and the bumps 311 are engaged to each other to fix the inner pipe 31 and the plug members 33 with each other. Each plug member 33 has a stopping portion 333 abutting a tail end of the inner pipe 31, preventing the plug member 33 from excessively entering the inner pipe 31. In addition, one end of each plug member 33 abuts the magnet 32, such that the two plug members 33 press the magnet 32 in opposite directions, and the entire rotor assembly 3 is in a tight fit. Since the components have size tolerances, the inner pipe 31 may be smaller, or the other portions of the rotor assembly 3 may be larger, such that the stopping portion 333 of one plug member 33 abuts one tail end of the inner pipe 31, and the magnet 32 and the two plug members 33 are both in tight fit, which may result in that the stopping portion 333 of the other plug member 33 does not abut the other tail end of the inner pipe 31. That is, a tiny interval may be formed between one stopping portion 333 and the tail end of the inner pipe 31. The elastic members 4 are accommodated in the plug members 33 and abut both the plug members 33 and the shell 1. In the present embodiment, the elastic members 4 are springs that stretch along with the movement of the rotor assembly 3, so as to provide an elastic force opposite to a moving direction of the rotor assembly 3. In the moving direction of the rotor assembly 3, a buffer member 34 is further provided between the shell 1 and each plug member 33 to absorb redundant kinetic energy, and in the present embodiment, the buffer member 34 is fixed to the corresponding plug member 33.

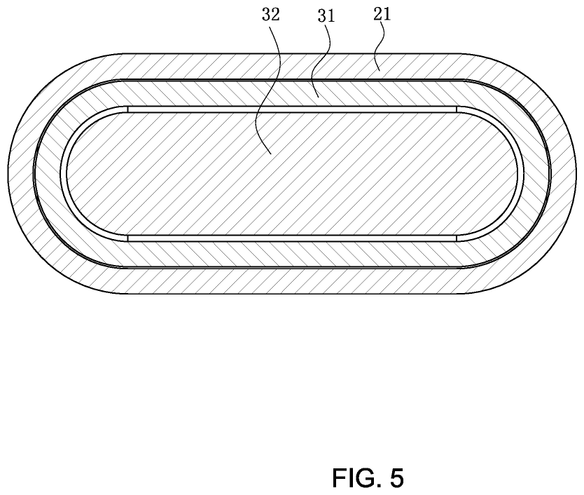

As shown in FIG. 5, a cross sectional shape of the outer pipe 21 is identical to a cross sectional shape of the inner pipe 31, and an inner diameter of the outer pipe 21 is slightly greater than an outer diameter of the inner pipe 31, such that the inner pipe 31 is capable of closely moving linearly along an extending direction of the outer pipe 21, thus reducing a volume of the electromagnetic actuator 100, and avoiding nonlinear movement of the electromagnetic actuator 100.

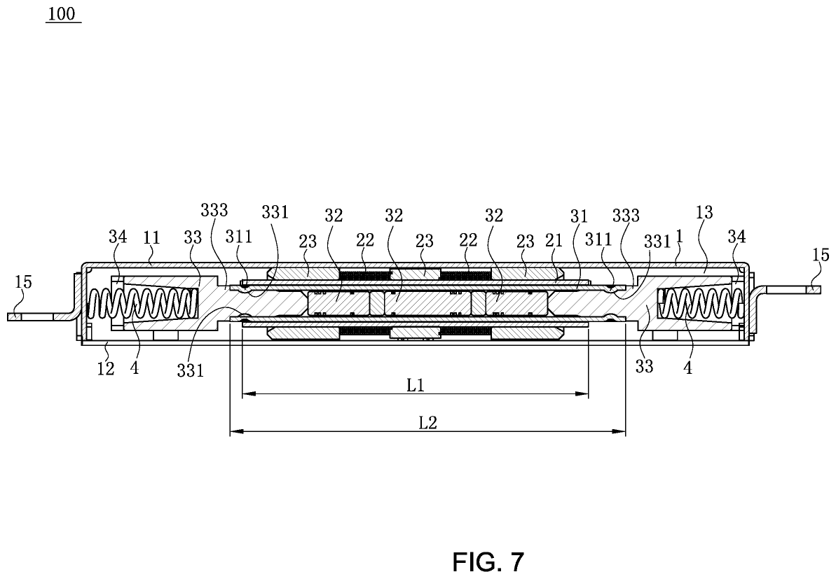

As shown in FIG. 6 and FIG. 7, in this embodiment, a longitudinal sectional shape of the outer pipe 21 and a longitudinal sectional shape of the inner pipe 31 are both rectangular, and a length of the inner pipe 31 is greater than a length of the outer pipe 21. When the rotor assembly 3 does not move, the outer pipe 21 medially sleeved over the inner pipe 31, which makes both tail ends of the inner pipe 31 exposed outside the outer pipe 21. Specifically, the outer pipe 21 is located at a center location of the inner pipe 31 in the longitudinal direction, such that the outer pipe 21 is “medially” sleeved over the inner pipe 31. In other words, in the longitudinal direction, a distance between one end of the outer pipe 21 and the inner pipe 31 equals to a distance between the other end of the outer pipe 21 and the inner pipe 31. When the coil 22 is powered and the rotor assembly 3 is driven to move along the extending direction of the outer pipe 21, a length of one end of the inner pipe 31 exposed out of the outer pipe 21 is increased along with the movement of the rotor assembly 3. The rotor assembly 3 compresses one elastic member 4, and a length of the other end of the inner pipe 31 exposed out of the outer pipe 21 is correspondingly decreased along with the movement of the rotor assembly 3. The other elastic member 4 is stretched by the rotor assembly 3, and the two elastic members 4 both generate elastic forces opposite to the moving direction thereof. When an instantaneous velocity of the rotor assembly 3 is decreased to zero, a moving stroke of the rotor assembly 3 from an initial position reaches a maximum value. In this case, the two tail ends of the inner pipe 31 both remain outside the outer pipe 21, and do not enter the outer pipe 21. After a one-way stroke of the rotor assembly 3 reaches the maximum value, the two elastic members 4 enable the rotor assembly 3 to return to its initial position through the elastic forces, and then the coil drives the rotor assembly 3 to move toward the opposite direction. This cycle is repeated, achieving a linear reciprocating vibration of the rotor assembly 3 along the outer pipe 21. Assuming that the length of the outer pipe 21 is L1, and the length of the inner pipe 31 is L2, in this embodiment, a maximum linear reciprocating stroke of the rotor assembly 3 is less than or equal to (L2-L1).

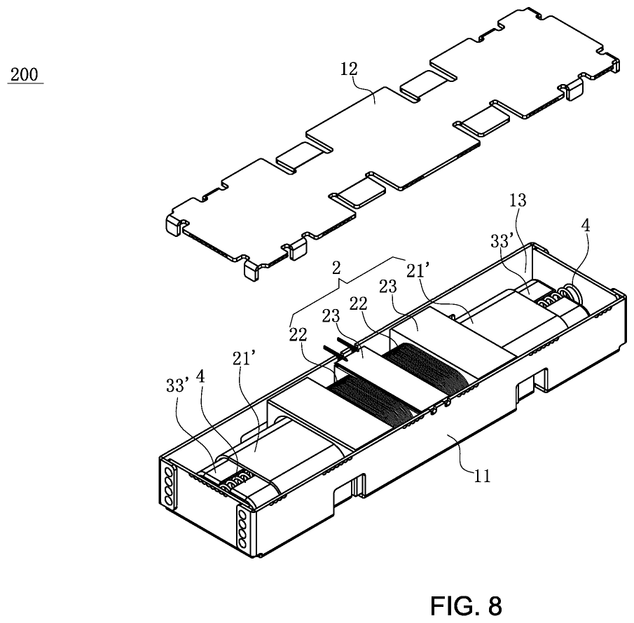

FIG. 8 to FIG. 11 show an electromagnetic actuator 200 according to a second embodiment of the present invention, which is different from the first embodiment in that the plug members 33′ and an inner pipe 31′ are fixed to each other through an adhering agent, and a length of the inner pipe 31′ is less than a length of an outer pipe 21′.

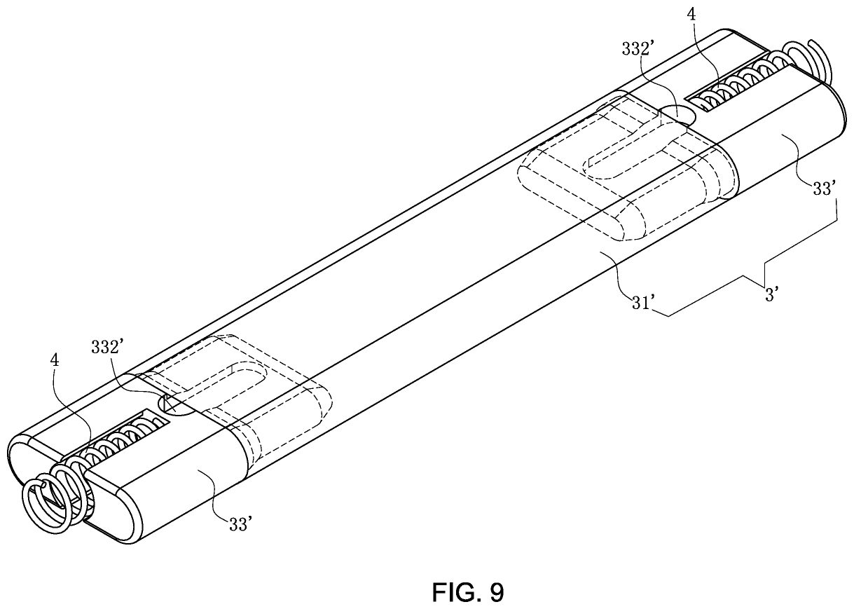

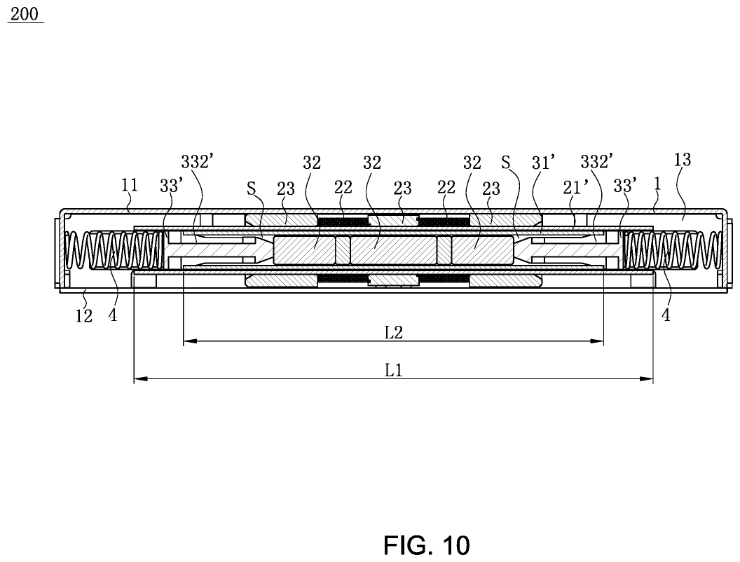

As shown in FIG. 9 and FIG. 10, each plug member 33′ is partially accommodated in the inner pipe 31′, and the portion being accommodated in the inner pipe 31′ is not in contact with an inner surface of the inner pipe 31′, such that a gap S is formed between each plug member 33′ and the inner pipe 31′. An upper surface and a lower surface of each plug member 33′ are respectively provided with a passage 332′, and the passage 332′ extends into the inner pipe 31′ from an exterior of the inner pipe 31′. That is, the passage 332′ is partially exposed out of the inner pipe 31′, and is partially accommodated in the inner pipe 31′. The passage 332′ is communicated with the gap S. The adhering agent enters the inner pipe 31′ through the passage 332′, and the gap S is filled with the adhering agent, such that the inner pipe 31′, the plug members 33′ and the magnet 32 are fixed and connected to each other to form a rotor assembly 3′.

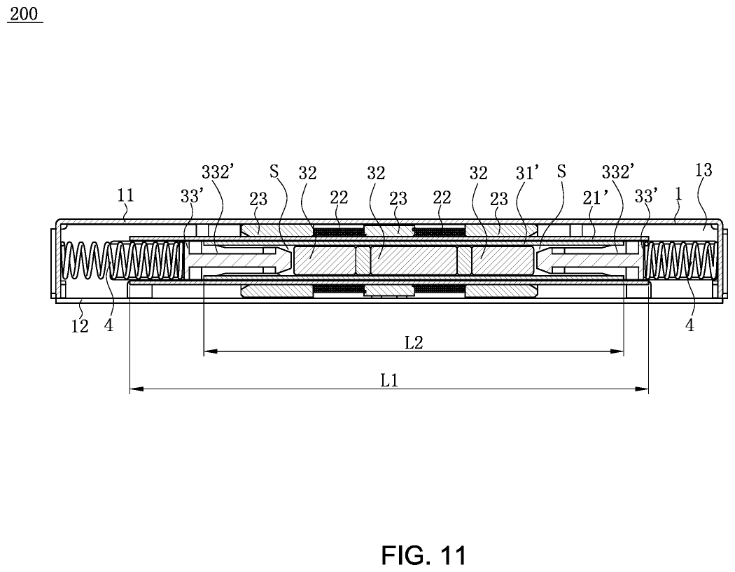

As shown in FIG. 10 and FIG. 11, the length of the inner pipe 31′ is less than the length of the outer pipe 21′. When the rotor assembly 3′ does not move, the inner pipe 31′ is medially accommodated in the outer pipe 21′. Specifically, the inner pipe 31′ is located at a center location of the outer pipe 21′ in the longitudinal direction, such that the inner pipe 31′ is “medially” accommodated in the outer pipe 21′. In other words, in the longitudinal direction, a distance between one end of the inner pipe 31′ and the outer pipe 21′ equals to a distance between the other end of the inner pipe 31′ and the outer pipe 21′. The coil is powered, the rotor assembly 3′ is driven to move along an extending direction of the outer pipe 21′. When a moving stroke of the rotor assembly 3′ from an initial position reaches to a maximum value, the two tail ends of the inner pipe 31′ are still accommodated in the outer pipe 21′. That is, in the moving process of the rotor assembly 3′, the inner pipe 31′ is completely accommodated in the outer pipe 21′ and is not exposed out of the outer pipe 21′. In this embodiment, the maximum stroke of linear reciprocating vibration of the rotor assembly 3′ is less than or equal to (L1-L2).

Combining the first embodiment and the second embodiment, the maximum stroke of the linear reciprocating vibration of the rotor assembly 3 or 3′ is equal to a difference value | L1-L2 | of a length L1 of the outer pipe 21 or 21′ and a length L2 of the inner pipe 31 or 31′. In other embodiments, the length of the outer pipe 21 or 21′ may also be equal to the length of the inner pipe 31 or 31′. However, in these embodiments, the maximum stroke of linear reciprocating vibration of the rotor assembly 3 or 3′ is unrelated to a difference value of the length of the outer pipe 21 or 21′ and the length of the inner pipe 31 or 31′.

If the magnet 32 moves in the outer pipes 21 or 21′ made of metal, it can be learned from the Lenz's law that the outer pipes 21 or 21′ made of metal generate an induction current, including an eddy current, hindering movement of the magnet. Since the induction current flows along pipe walls of the outer pipes 21 or 21′, the outer pipes 21 or 21′ made of metal are provided with grooves to hinder generation of the induction current.

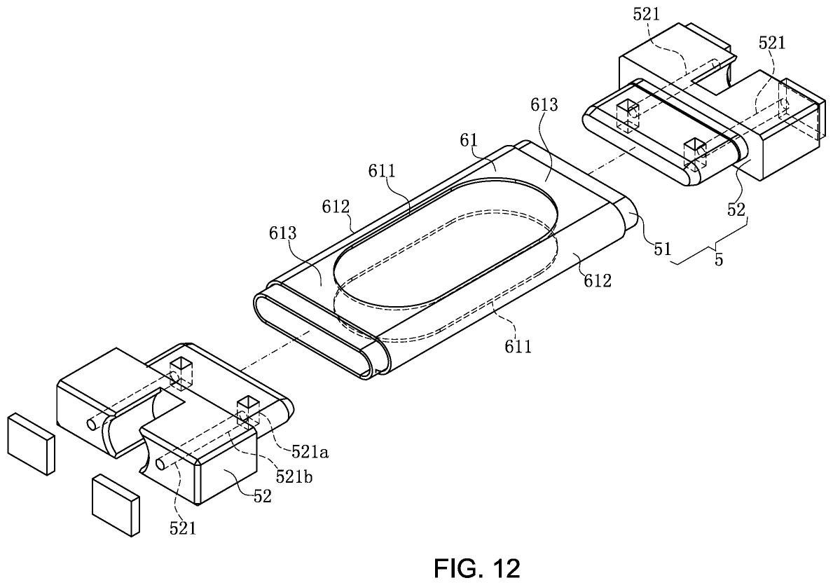

FIG. 12 shows a rotor assembly 5 and an outer pipe 61 sleeved over the rotor assembly 5 of an electromagnetic actuator according to a third embodiment of the present invention. The rotor assembly 5 includes an inner pipe 51 sleeved in the outer pipe 61, two plug members 52 fixed to two ends of the inner pipe 51, and at least two magnets (not shown) accommodated in the inner pipe 51 and clamped between the two plug members 52. In this embodiment, an inner pipe 51 and two plug members 52 forming the rotor assembly 5 are fixed to each other through an adhering agent. Each plug member 52 has two passages 521 for introduction of the adhering agent. The passages 521 includes a vertical passage 521a running through the upper and lower surfaces of each plug member 52 to form exits (not labeled), and a horizontal passage 521b communicating an entrance (not labeled) and the vertical passage 521a. The difference in this embodiment from the second embodiment exists in that, the passages 521, except for their entrances and exits, are hidden in the corresponding plug member 52, and are not exposed on surfaces of the corresponding plug member 52. This embodiment is also different from the previous embodiments in that the upper and lower pipe walls of the outer pipe 61 are provided with two grooves 611. The grooves 611 run through the pipe walls. A length of each groove 611 is greater than ½ of a length of the outer pipe 61, and a total area of the two grooves 611 is greater than a surface area of a metal portion of the outer pipe 61. That is, the total area of the two grooves 611 is greater than a surface area of the portion on the outer pipe 61 not provided with the slots, so as to better hinder the generation of the induction current. In this embodiment, the outer pipe 61 has two side walls 612 and two connecting portions 613 located between the grooves 611 and two tail ends of the outer pipe 61. The two connection parts 613 are used for connecting the two side walls 612. Implementations of other components not specifically mentioned in this embodiment may be referenced to the first and second embodiments, and thus are not hereinafter elaborated.

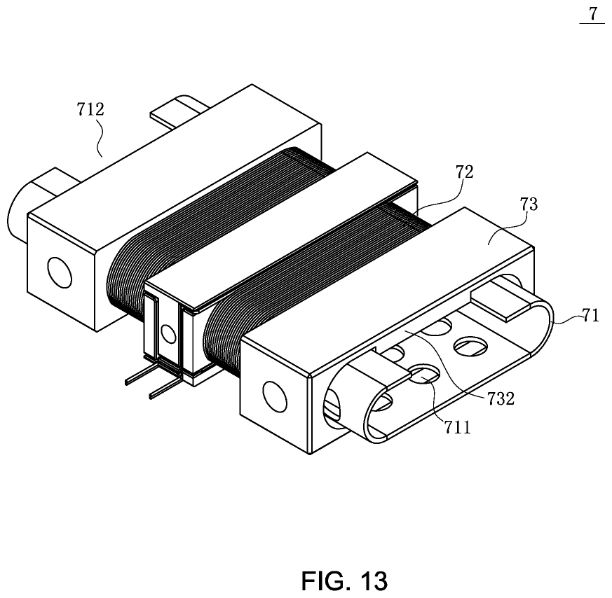

FIG. 13 to FIG. 15 show a stator assembly 7 of an electromagnetic actuator according to a fourth embodiment of the present invention. The stator assembly 7 includes a longitudinal outer pipe 71, two coils 72 wound on an outer surface of the outer pipe 71, and three fixing members 73 provided at intervals with the two coils. The outer pipe 71 has a plurality of grooves 711 and an opening 712 communicating two tail ends of the outer pipe 71. The opening 712 divides the outer pipe 71 along an extending direction of the outer pipe 71, such that an induction current does not to flow along a cross section of the outer pipe 71, thereby weakening the impact of the induction current. The fixing member 73 has an accommodating cavity 731, and the outer pipe 71 is engaged and sleeved in the accommodating cavity 731. A cross section of the accommodating cavity 731 is matched with a cross section of the outer pipe 71, thus preventing the outer pipe from expanding and deforming due to self-tension. The outer pipe 71 further includes a protruding block 732 protruding and extending toward the accommodating cavity 731, and the protruding block 732 enters the opening 712 to prevent the opening 712 from being closed. Implementations of other components not specifically mentioned in this embodiment may be referenced to the first and second embodiments, and thus are not hereinafter elaborated.

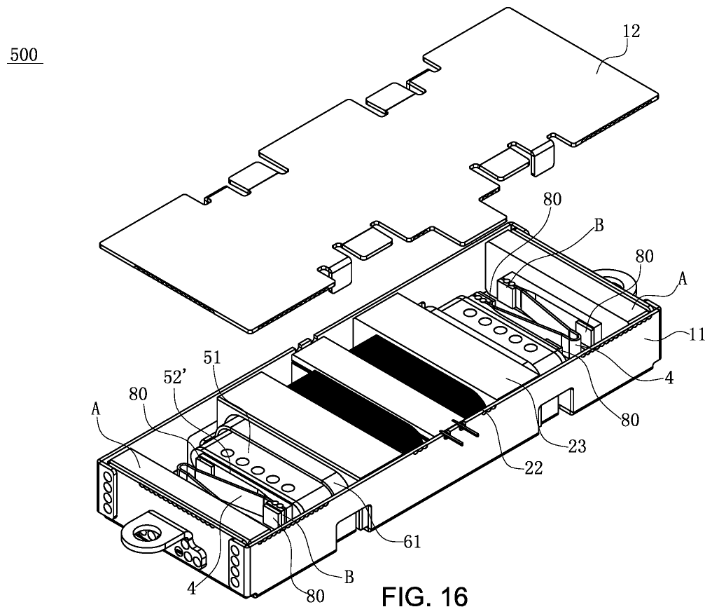

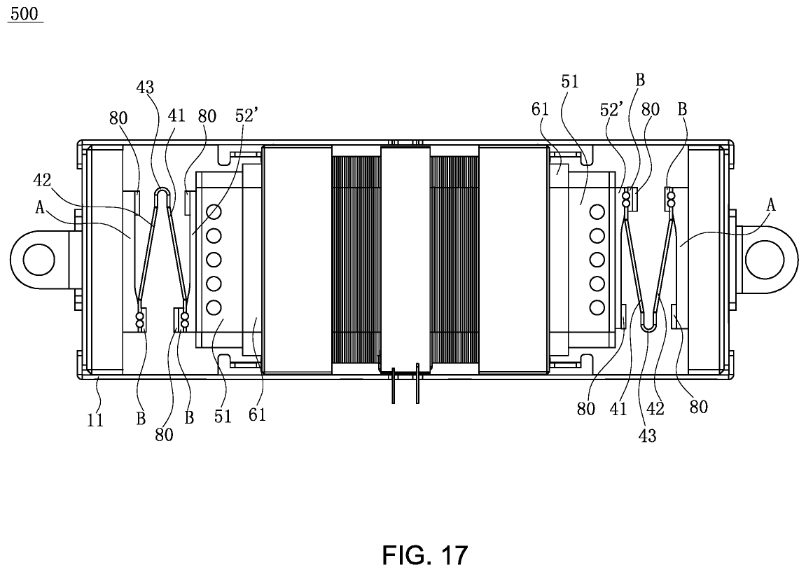

FIG. 16 and FIG. 17 show an electromagnetic actuator 500 according to a fifth embodiment of the present invention, which is different from the third embodiment in that each of the elastic member 4 is a leaf spring made of metal. In this embodiment, each elastic member 4 is substantially V-shaped, including a first elastic sheet 41, a second elastic sheet 42 and a bending portion 43 connecting the first elastic sheet 41 and the second elastic sheet 42. A tail end of the first elastic sheet 41 is attached to a plug member 52′ made of metal by laser spot welding. The plug member 52′ is inserted into the inner pipe 51 which is made of metal. The upper and lower surfaces of the plug member 52′ are tightly attached to the inner surface of the inner pipe 51, and then the plug member 52′ and the inner pipe 51 are fixed to each other by laser spot welding. Two ends of the first shell 11 in the longitudinal direction are correspondingly provided with two outer fixing members A, and the tail ends of the second elastic sheet are attached to the outer fixing members A by laser spot welding, and thus are fixed and connected to the first shell 11. In this embodiment, two reinforcing sheets B made of metal are further provided. One of the reinforcing sheets B and the plug member 52′ clamp the first elastic sheet 41, and the other of the reinforcing sheets B and the outer fixing members A clamp the second elastic sheet 42, thus increasing the spot welding area, such that the elastic member 4 can be stably soldered and fixed to the plug member 52′ and the outer fixing members A. In this embodiment, three buffer members 80 made of silicone material are further provided. One of the buffer members 80 is attached to the plug member 52′ and located between the plug member 52′ and the bending portion 43. Another of the buffer members 80 is attached to one of the reinforcing sheets B and located between the two reinforcing sheets B. Further, the other of the buffer members 80 is attached on the outer fixing member A and located between the outer fixing member A and the bending portion 43. The elastic member 4 is a leaf spring and not a regular spring, thus avoiding the elastic member 4 from arching toward directions other than the stretching direction thereof, thereby preventing the elastic member 4 from scratching other components. Implementations of other components not specifically mentioned in this embodiment may be referenced to the first and second embodiments, and thus are not hereinafter elaborated.

To sum up, the electromagnetic actuator according to certain embodiments of the present invention has the following beneficial effects:

1. The outer pipes 21, 21′, 61, and 71 are made of metal. Compared with resin of a same thickness, the strength of the outer pipes 21, 21′, 61, and 71 can be improved, preventing the outer pipes 21, 21′, 61, and 71 from deforming and interfering with movement of the inner pipes 31, 31′, and 51, thereby improving stability of the electromagnetic actuator. Compared with resin of the same strength, a thickness of a pipe wall can be reduced, such that the coils 22 and 72 are closer to the magnet 32, improving a driving effect of the coils 22 and 72 on the magnet 32, and reducing the volume thereof.

2. When the magnet moves in the outer pipes 21, 21′, 61, and 71 made of metal, due to the Lenz's law, the outer pipes 21, 21′, 61, and 71 generate an induction current hindering movement of the magnet. By providing with the grooves 611 and 711 on the outer pipes 21, 21′, 61, and 71 made of metal, the generation of the induction current can be hindered.

3. The surface of the plug member 33 is provided with the recesses 331, and the inner surface of the inner pipe 31 is provided with the bumps 311. The bumps 311 and the recesses 331 are engaged with each other, such that the rotor assembly 3 is closely and steadily assembled, and an assembling process is simple and reliable.

4. The plug members 33′ and 52 are provided with the passages 332′ and 521 for guiding the adhering agent into the inner pipes 31′ and 51, such that the inner pipes 31′ and 51, the plug members 33′ and 52 and the magnet are closely and steadily combined to form the rotor assemblies 3′ and 5. Further, the case where that outer surfaces of the rotor assemblies 3′ and 5 is coated with the adhering agent, thus affecting consequently movement of the rotor assemblies 3′ and 5 can be avoided.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An electromagnetic actuator, comprising:
a rotor assembly, comprising an inner pipe and at least one magnet accommodated in the inner pipe;
a stator assembly, sleeved over the rotor assembly, wherein the stator assembly comprises an outer pipe made of metal and sleeved over the inner pipe and at least one coil fixed outside the outer pipe, the at least one coil applies a driving force to the at least one magnet, and the at least one magnet drives the entire rotor assembly to move along an extending direction of the outer pipe; and
at least one elastic member, located at one end of the rotor assembly,
wherein an outer diameter of the inner pipe is less than an inner diameter of the outer pipe, and a shape of the outer pipe is identical to a shape of the inner pipe.

2. The electromagnetic actuator according to claim 1, wherein the inner pipe is made of metal.

3. The electromagnetic actuator according to claim 1, wherein a length of the outer pipe is less than a length of the inner pipe, and when the rotor assembly moves, two tail ends of the inner pipe remain outside the outer pipe.

4. The electromagnetic actuator according to claim 3, wherein when the rotor assembly does not move, the outer pipe is medially sleeved over the inner pipe.

5. The electromagnetic actuator according to claim 1, wherein a length of the outer pipe is greater than a length of the inner pipe, and when the rotor assembly moves, the entire inner pipe is completely accommodated in the outer pipe.

6. The electromagnetic actuator according to claim 5, wherein when the rotor assembly does not move, the inner pipe is medially accommodated in the outer pipe.

7. The electromagnetic actuator according to claim 1, wherein two ends of the inner pipe are provided with two plug members.

8. The electromagnetic actuator according to claim 7, wherein an inner surface of the inner pipe has two bumps, each of the plug members has a recess, and each of the bumps and the corresponding recess engage with each other so as to fix the plug members to the inner pipe.

9. The electromagnetic actuator according to claim 7, wherein each of the plug members has a passage, and the passage extends into the inner pipe from an exterior of the inner pipe.

10. The electromagnetic actuator according to claim 7, wherein at least one of the two plug members is provided with a stopping portion abutting a tail end of the inner pipe in an extending direction of the inner pipe.

11. The electromagnetic actuator according to claim 1, wherein a longitudinal sectional shape and a cross sectional shape of the outer pipe are respectively identical to a longitudinal sectional shape and a cross sectional shape of the inner pipe.

12. The electromagnetic actuator according to claim 1, wherein at least one groove is provided between two tail ends of the outer pipe, configured to reduce an eddy current generated on the outer pipe when the magnet moves along the outer pipe.

13. The electromagnetic actuator according to claim 1, wherein the electromagnetic actuator is accommodated in a shell, and the elastic member is a leaf spring, comprising:
a first elastic sheet connected to the rotor assembly;
a second elastic sheet connected to the shell; and
a bending portion connecting the first elastic sheet and the second elastic sheet.

14. An electromagnetic actuator, comprising:
a rotor assembly, comprising two magnets; and
a stator assembly, sleeved over the rotor assembly, wherein the stator assembly comprises an outer pipe made of metal and sleeved over the magnets and at least one coil fixed outside the outer pipe, the at least one coil applies a driving force to the magnets, and the magnets drive the entire rotor assembly to move along an extending direction of the outer pipe,
wherein the outer pipe is provided with at least one groove used configured to reduce an eddy current generated on the outer pipe when the magnets move along the outer pipe.

15. The electromagnetic actuator according to claim 14, wherein a length of the groove is greater than ½ of a length of the outer pipe.

16. The electromagnetic actuator according to claim 14, wherein an area of the groove is greater than an area of a metal portion of the outer pipe.

17. The electromagnetic actuator according to claim 14, wherein the outer pipe has two side walls and two connecting portions, each of the two connecting portions is located between the groove and a corresponding one of two tail ends of the outer pipe, and the connecting portions are configured to connect the two side walls.

18. The electromagnetic actuator according to claim 14, wherein the stator assembly further comprises at least one fixing member, and one of the at least one fixing member has a protruding block accommodated in one of the at least one groove.

19. The electromagnetic actuator according to claim 14, wherein the at least one groove is located between two tail ends of the outer pipe.

20. The electromagnetic actuator according to claim 14, wherein the rotor assembly further comprises an inner pipe accommodating the magnets, the inner pipe and the magnets jointly move, and the outer pipe is sleeved over the inner pipe.

21. The electromagnetic actuator according to claim 14, further comprising at least one elastic member provided on at least one end of the rotor assembly.

22. The electromagnetic actuator according to claim 14, wherein the electromagnetic actuator is accommodated in a shell, and the elastic member is a leaf spring, comprising:
a first elastic sheet connected to the rotor assembly;
a second elastic sheet connected to the shell; and
a bending portion connecting the first elastic sheet and the second elastic sheet.
